(19) United States
(12) Patent Application Publication
(10) Pub. No.: US 2007/0260406 A1
(43) Pub. Date: Nov. 8, 2007

(54) AUTOMATED LOCATION SYSTEM

(75) Inventors: Simon B. Johnson, Bonney Lake, WA (US); Lev M. Bolotin, Kirkland, WA (US); Bradley Morris Johnson, Edmonds, WA (US)

Correspondence Address: ISHIMARU & ZAHRT LLP, 333 W. EL CAMINO REAL, SUITE 330, SUNNYVALE, CA, 94087, US

(73) Assignee: DATA I/O CORPORATION, Redmond, WA (US)

(21) Appl. No.: 11/743,542

(22) Filed: May 2, 2007

Related U.S. Application Data
(60) Provisional application No. 60/746,362, filed on May 3, 2006.

(51) Int. Cl. G06F 19/00; G06K 9/00; G01N 21/00

(52) U.S. Cl. 702/40; 702/127; 702/1; 702/33; 702/35; 702/36; 356/237.1; 356/237.2; 356/237.3; 356/237.4; 356/237.5; 382/100; 382/108; 382/141; 382/145

(57) ABSTRACT

An automated location system that includes providing the number of rows and columns of a receptacle to the automated location system; scanning the receptacle to determine changes in reflectivity; creating an X values list and a Y values list from the scan; and determining a location for each of a cavity from the X values list and from the Y values list.

### CROSS-REFERENCE TO RELATED APPLICATION(S)

This application claims the benefit of U.S. Provisional Patent Application Ser. No. 60/746,362 filed May 3, 2006.

The present application contains subject matter related to co-pending U.S. patent application Ser. No. 11/381,532. The related application is assigned to Data I/O Corporation.

### TECHNICAL FIELD

The present invention relates generally automated systems, and more particularly to an automated location system.

### BACKGROUND ART

In general, a pick-and-place machine contains a nozzle for the purpose of picking and placing components. This nozzle is usually mounted on a moveable head, often referred to as a pick-and-place head, which allows transporting of components between different locations within the working envelope of a robot. The location of the nozzle is known at all times via the use of encoders, which track the nozzle location through a two dimensional coordinate system (i.e.—X and Y). In order for components to be picked and placed accurately within the working envelope of the pick-and-place machine, the destinations have to be known absolutely. Presently, most systems learn exact destinations by having an operator manually teach the module picking positions and placing positions.

The reference point for any encoder is the home position. The home position is determined by moving along any axis in the direction of the home flag, until a home detection sensor is activated. This process provides a reference point for all head movements. Although the home position provides a reference point, it is only a reference point relative to other positions.

While the home position can be detected quite accurately, tray pocket locations, such as input/output module cavities and programming module cavities, within the robot working envelope are known to an approximate value. Consequently, the locations of tray pockets are not known accurately enough for pick-and-place operations.

Presently, most pick-and-place operations require manual teaching of the exact location of a tray pocket cavity by an operator. This is an extremely time consuming process that requires the following steps: home location, approximate cavity location, exact component location, and coordinate storage. First, an operator must locate the home coordinate system by aligning the robot with the home detection sensors for each coordinate axis (i.e.—X and Y). Next, the operator repositions the robot to the approximate location of the cavity. Then, with the nozzle in the down position, the operator mainly “jogs” the pick-and-place head until the nozzle meets a reference feature, such as a component or center of cavity.

Once a visual check by the operator has ascertained that the nozzle is positioned at the correct destination, the operator instructs the robot to remember the current coordinates. This procedure is repeated until all the reference features (e.g.—tray pocket cavities) have been determined by the coordinate system. Not only is this process costly and time consuming, it is also fraught with human error such as unsophisticated operator visual identification steps. Additionally, with automated programming systems, where the modules need to be exchanged quite often, productivity is severally curtailed due to time spent on additional machine setup steps and operator learning curve.

Consequently, additional methods for locating a tray pocket cavity have been developed. For example, another manual method for teaching tray pocket cavity location is to copy the specified Joint Electron Device Engineering Council (JEDEC) critical dimensions of a tray, such as pocket pitch along row (M2), pocket pitch along column (M3), row offset from top left corner (M1), column offset from top left corner (M), number of rows (N2), and number of columns (N1), into a local database. The pick and place equipment can then use these dimensions in conjunction with a calibrated reference point to locate the tray pockets. Unfortunately, tray specifications (both JEDEC and non-standard) are difficult to locate, so further methods need to be developed.

Thus, a need still remains for a reliable automated location system and method of application, wherein the automated location system does not require a high level of operator interaction to locate features. In view of the ever-increasing commercial competitive pressures, increasing consumer expectations, and diminishing opportunities for meaningful product differentiation in the marketplace, it is increasingly critical that answers be found to these problems. Moreover, the ever-increasing need to save costs, improve efficiencies, and meet such competitive pressures adds even greater urgency to the critical necessity that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides an automated location system that includes providing the number of rows and columns of a receptacle to the automated location system; scanning the receptacle to determine changes in reflectivity; creating an X values list and a Y values list from the scan; and determining a location for each of a cavity from the X values list and from the Y values list.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is an isometric view of an automated programming system in accordance with an embodiment of the present invention;

FIG. 2 is an isometric view of an automated programming system with a cover removed in accordance with an embodiment of the present invention;

FIG. 3 is an overview of an automated location system in accordance with an embodiment of the present invention;

FIG. 4 is a plan view of a receptacle in accordance with an embodiment of the present invention;

FIG. 5 is an exemplary initial path of travel over a receptacle for an optics system, in accordance with an embodiment of the present invention;

FIG. 6 is a graph of exemplary results of an optics scan in accordance with an embodiment of the present invention;

FIG. 7 is a graph of the exemplary results of a scan across a receptacle, in accordance with an embodiment of the present invention;

FIG. 8 is the structure of FIG. 7 after removal of a signal start trace and a signal stop trace, in accordance with an embodiment of the present invention;

FIG. 9 is the structure of FIG. 8, after removal of a false signal, in accordance with an embodiment of the present invention;

FIG. 10 is the structure of FIG. 9, after determining pitch between openings in accordance with an embodiment of the present invention;

FIG. 11 is the structure of FIG. 10 with a fourth prime opening removed, in accordance with an embodiment of the present invention;

FIG. 12 is the structure of FIG. 11, after filling in a third opening and a sixth opening, in accordance with an embodiment of the present invention;

FIG. 13 is a graph of a scan along a first axis after performing steps three through eleven, in accordance with an embodiment of the present invention; and

FIG. 14 is a flow chart of an automated location system for an automated location system, in accordance with an embodiment of the present invention.

### BEST MODE FOR CARRYING OUT THE INVENTION

The following embodiments are described in sufficient detail to enable those skilled in the art to make and use the invention, and it is to be understood that other embodiments would be evident based on the present disclosure and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known system configurations, and process steps are not disclosed in detail. Likewise, the drawings showing embodiments of the invention are semi-diagrammatic and not to scale and, particularly, some of the dimensions are for the clarity of presentation and are shown exaggerated in the drawing FIGS. In addition, where multiple embodiments are disclosed and described having some features in common, for clarity and ease of illustration, description, and comprehension thereof, similar and like features one to another will ordinarily be described with like reference numerals.

The term “horizontal” as used herein is defined as a plane parallel to the plane or surface of a receptacle, regardless of its orientation. The term “vertical” refers to a direction perpendicular to the horizontal as just defined. Terms, such as “on”, “above”, “below”, “bottom”, “top”, “side” (as in “sidewall”), “higher”, “lower”, “upper”, “left”, “right”, “over”, and “under”, are defined with respect to the horizontal plane. The terms “example” or “exemplary” are used herein to mean serving as an instance or illustration. Any aspect or embodiment described herein as an “example” or “exemplary” are not necessarily to be construed as preferred or advantageous over other aspects or designs.

Generally, the automated location system of the present invention relates to the determination of a feature location within a system. The purpose of determining a feature location is to establish a correlation between the location of the feature and a common point of reference, wherein an element of the system may utilize this information.

More specifically, the automated location system of the present invention can be used to map features (i.e.—tray pocket locations) within the boundaries of a receptacle, such as a JEDEC tray. Commonly, these receptacles are placed within an automated placement machine or within an automated programming system, thereby allowing transport of components to and from the receptacle features for further processing.

Typically, these receptacles may contain a number of features, such as cavities or pockets, each capable of containing a component therein. The physical dimensions for each cavity are generally similar and the cavities are usually arranged in a uniform configuration. By way of example, the receptacle employed by the present invention may include a uniform configuration with an array of columns and rows defining the cavity locations, wherein the columns are substantially centered between the left and right edges of the receptacle and the rows are substantially centered between the top and bottom edges of the receptacle. Per this invention, columns substantially centered between the left and right edges of the receptacle means that the distance from the left edge of the receptacle to the center of the first column is substantially similar to the distance from the right edge to the center of the last column and rows substantially centered between the top and bottom edges of the receptacle means that the distance from the top of the tray to the first row is substantially similar to the distance from the bottom edge to the center of last row.

By employing receptacles with substantially similar cavity physical dimensions and substantially centered columns and rows, the present inventors have discovered a system that makes it possible to calculate the relative spatial coordinates (i.e.—location) of each of the components contained within these cavities with respect to a common point of reference. After determining the coordinate positions of each of the components, an automated placement machine or an automated programming system, for example, may be programmed to successively move to each coordinate position, corresponding to the location of the components, in order to retrieve each of the components from its respective cavity for further processing.

Generally, the receptacles employed by the present invention should also have openings centered within the cavities or pockets and there should also be at least two cavities or pockets located side-by-side, wherein the side-by-side cavities or pockets contain openings.

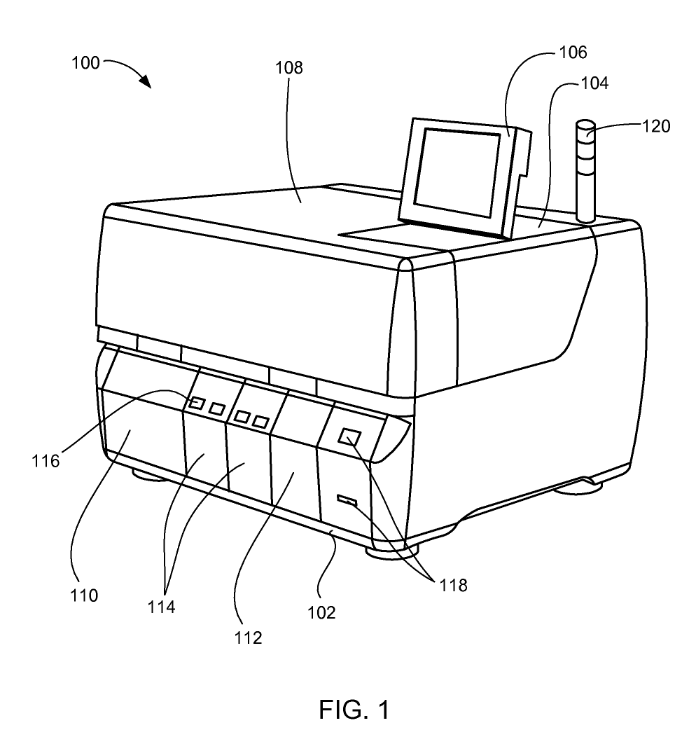

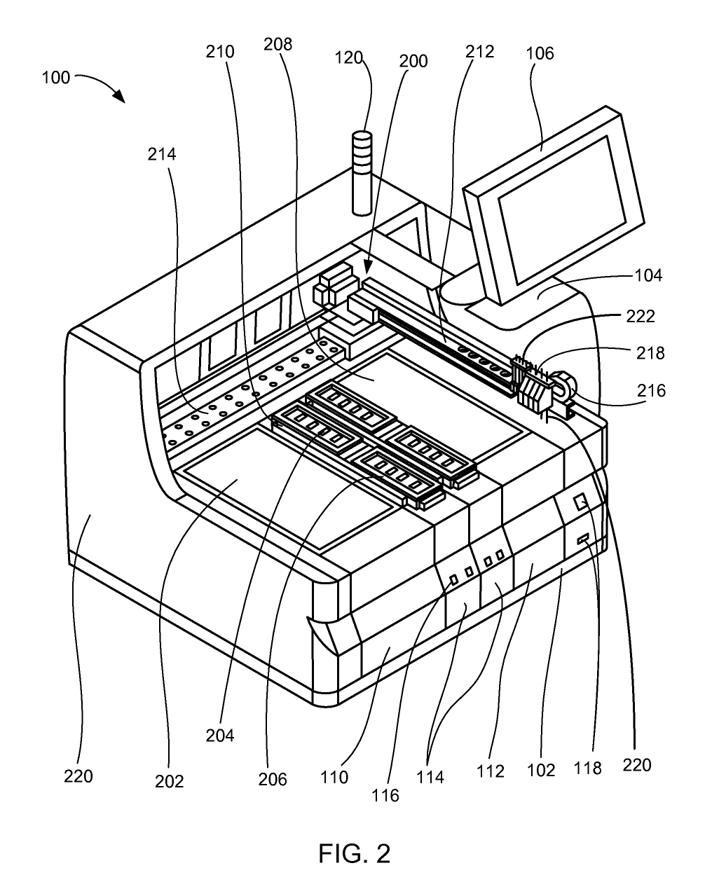

FIGS. 1 and 2 depict an exemplary apparatus that may employ the automated location system in accordance with an embodiment of the present invention. It is to be understood that FIGS. 1 and 2 depict by way of example and not by limitation, an exemplary apparatus that may employ the automated location system, and it is not to be construed as limiting.

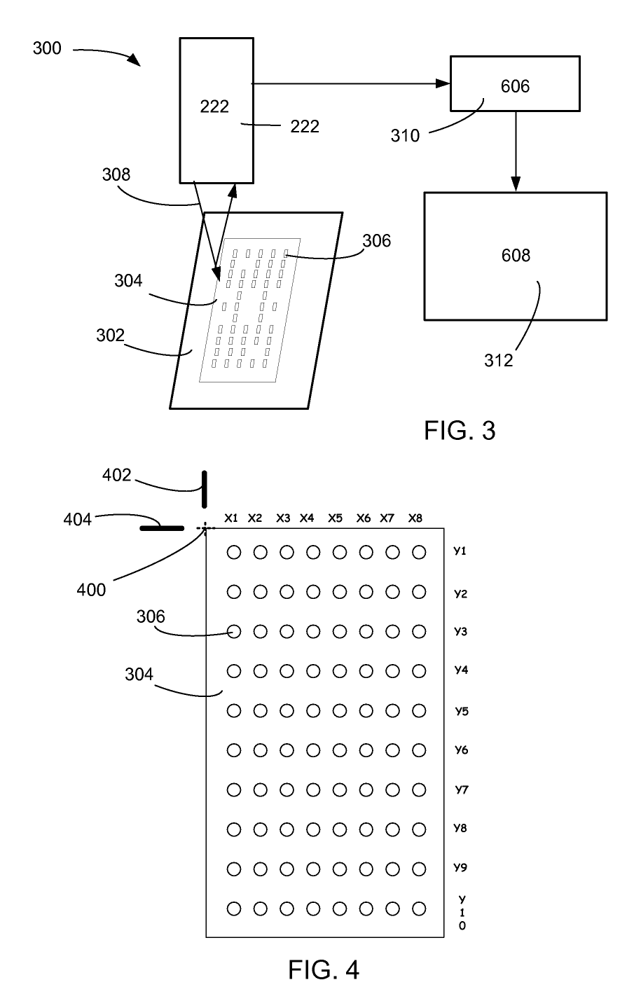

Referring now to FIG. 1, therein is shown an isometric view of an automated programming system 100 in accordance with an embodiment of the present invention. The automated programming system 100 includes a frame 102, a stand 104, a monitor 106, a cover 108, an input module 110, an output module 112, programming modules 114, a module control 116, control electronics 118, and a status indicator 120. As an exemplary illustration, the automated programming system 100 may include an automated location system 300, of FIG. 3, within a desktop handler system employing a pick-and-place mechanism. The desktop handler system is a portable programming system wherein handles may be built-in to enhance portability.

The frame 102 is the main housing that holds all the elements together and provides structural support. The stand 104 can provide support for the monitor 106. By way of example and not by way of limitation, the monitor 106 may include a touch screen user interface system that provides visual feedback to an operator.

The cover 108 is also mounted to the frame 102 and covers the working envelope of the machine. The cover 108 offers protection to the input module 110, the output module 112, and the programming modules 114 from dust and debris within the working environment. Additionally, the cover 108 protects an operator from unintended operational hazards.

Devices, media and/or components may enter and exit the automated programming system 100 via removable modules, such as the input module 110 or the output module 112. By way of example, the input module 110 and the output module 112 may be configured to accommodate trays, receptacles or other carriers, which may conform to Joint Electron Device Engineering Council (JEDEC) standards. However, it is to be understood that the present invention is not to be limited to such configurations. In accordance with the present invention the input module 110 and the output module 112 may accommodate any device tray, receptacle or carrier.

The programming modules 114 provide the core processing interface for the automated programming system 100. The programming modules 114 include one or more removable modules that interface with the automated programming system 100. Each of the programming modules 114 may also be configured to accommodate trays or carriers, which may conform to JEDEC standards. These trays or carriers may contain a socket adapter(s) 204, of FIG. 2, an actuator(s) 206, of FIG. 2, and a reject bin 210, of FIG. 2, for receiving devices. After the devices, such as un-programmed programmable media, are placed within the socket adapters, the actuators close the sockets so that the devices are appropriately connected to the programming modules 114 of the automated programming system 100.

Additionally, each of the programming modules 114 possesses the module control 116. The module control 116 allows an operator to initiate system configuration setup, such as the identification of the module, the configuration of the module, the geometry of the module and the location of the module within the system, by manually engaging the module control 116.

The control electronics 118 are also mounted on the frame 102. The control electronics 118 provide an electrical interface for the automated programming system 100. For example, the control electronics 118 may possess a power ON/OFF switch and/or digital air boards.

Notably, the automated programming system 100 does not rely on an external vacuum system, which greatly enhances the portability of the machine. The automated programming system 100 possesses an on-board vacuum system that is powered by electrical current, therefore, the automated programming system 100 is a self-sufficient system that only requires an electrical current for operation. Additionally, the back of the automated programming system 100 may possess additional power modules.

The status indicator 120 is also mounted on the frame 102. The status indicator 120 provides visual feedback, via a non-text error message, to the user about operation status. As an exemplary illustration, the status indicator 120 may use a multi-color scheme employing more than one light combination. The particular combination can be done in such a way that a green light indicates that everything is operation normal, a yellow light indicates that attention may be needed soon and a red light indicates that there is a problem or error, and operations should or will be stopped. According to this illustration, a red light requires immediate operator attention. However, it is to be understood that any color scheme may be used to convey the notions of operations normal, attention may be needed soon, and operation error.

For purposes of illustration, the following color coded combinations may occur:
Green=machine is running
Yellow=machine performance has degraded and may result in the machine eventually stopping
Red=machine is stopped. This can be from an error or normal termination of job.

Referring now to FIG. 2, therein is shown an isometric view of the automated programming system 100 with the cover 108, of FIG. 1, removed in accordance with an embodiment of the present invention. The automated programming system 100 includes the frame 102, the stand 104, the monitor 106, the input module 110, the output module 112, the programming modules 114, the module control 116, the control electronics 118, the status indicator 120, a robotics system 200, an input device receptacle area 202, the socket adapters 204, the actuators 206, an output device receptacle area 208, the reject bin 210, a gantry 212, a track 214, an arm 216, a head system 218, nozzles 220, and an optics system 222.

The robotics system 200, and more generally the automated programming system 100, can be controlled by a user interface system, such as a graphical non-text user interface system. In accordance with the scope of the present invention, a non-text user interface system uses only numbers and symbols to communicate information to an operator and not written words. The user interface system can provide feedback to an operator via visual or auditory stimulus.

The user interface system, displayed by the monitor 106, provides a real time image of the working envelope (i.e.—the system configuration). The working envelope includes the input module 110, the output module 112, the programming modules 114, the input device receptacle area 202, the socket adapters 204, the actuators 206, the output device receptacle area 208, and the reject bin 210.

By modeling the real time configuration of the working envelope, the monitor 106 helps to eliminate operator mistakes during set up of the automated programming system 100. Additionally, the real time image on the monitor 106 can increase operator productivity due to its accurate representation of the working envelope.

Not only does the user interface system display a real time image of the working envelope, but it may also provide programming setup and status information. In general, the user interface system of the present invention includes the following categories to control a programming system: job selection, programming, device and hardware detection, and statistical job feedback. These categories are controlled via a plethora of functions, such as job status inquires, job control, job tools, socket use, job selection, receptacle map, and measure receptacle. These functions provide a workable user interface for the automated programming system 100 that do not require textual representation, and therefore allow global application of the user interface.

Additionally, the user interface system can be configured for remote operation, as well as, remote diagnostics access.

During operation, the robotics system 200, which includes a pick-and-place system (e.g.—the head system 218), retrieves one or more devices (not shown) from the input device receptacle area 202, located over the input module 110. The robotics system 200 then transports the device(s) to the programming modules 114 which possess the socket adapters 204 and the actuators 206. Once the socket adapters 204 engage the devices, programming may commence. Once programming is complete, the robotics system 200 then transports the good devices to the output device receptacle area 208, located over the output module 112, and transports the bad devices to the reject bin 210. By way of example, the input device receptacle area 202 and the output device receptacle area 208 may be designed to accommodate device trays or carriers with one or more pockets.

The robotics system 200 is attached to an L-shaped base, which is part of the frame 102. The L-shaped base provides a rigid, lightweight, cast, platform for the robotics system 200. Additionally, the L-shaped base allows easy access to the working envelope of the automated programming system 100. The L-shaped base may contain a smart interface system for interfacing with intelligent modules.

The robotics system 200 includes the gantry 212, the track 214, the arm 216, the head system 218, the nozzles 220, and the optics system 222. The gantry 212 supports the arm 216, the head system 218, the nozzles 220 and the optics system 222. The gantry 212 slides back and forth (e.g.—in the X direction) across the track 214. The head system 218, the nozzles 220, and the optics system 222 slide back and forth (e.g.—in the Y direction) across the arm 216 supported by the gantry 212. The head system 218 may additionally move up and down (i.e.—in the Z direction) and rotate (i.e.—in the theta direction).

The head system 218, may include by way of example and not by way of limitation, a pick-and-place head system, which can employ multiple design configurations, such as a multi-probe design. The head system 218 is a small sized, lightweight system to facilitate fast and accurate movements. Imprecise movements of the head system 218 are accommodated for by a built-in compliance mechanism. The built-in compliance mechanism can be based upon mechanical principles, such as a spring, or upon electrical principles, for example.

In further attempts to reduce the size and weight of the head system 218, particular aspects of the invention may employ limited theta or rotational movement for each up and down or Z position.

The head system 218 may be powered by an electrical stimulus, a pneumatic stimulus or any stimulus that produces the desired result of moving the head system 218. Uniquely, the nozzles 220 of the head system 218 do not rely on an external air supply. If pneumatics is used to operate the nozzles 220, they are provided via an on-board vacuum system. Therefore, the automated programming system 100 can be designed to only require electrical power for operation. By not requiring each potential operations facility to possess a clean and special external air supply, the automated programming system 100 becomes universally portable and employable.

Furthermore, adjacent to the head system 218 is the optics system 222 that is displaceable due to its attachment to the head system 218. The optics system 222 enables the automated programming system 100 to automatically map the physical characteristics and geometry of a receptacle 304, of FIG. 3, placed within the input device receptacle area 202 and the output device receptacle area 208 of the automated programming system 100. By way of example, for each of the receptacle 304 placed within the automated programming system 100, the optics system 222 can automatically map the physical characteristics of the tray, such as the row offset, the row pitch, the column offset, and the column pitch to determine the location of each feature or opening within the receptacle 304.

These automatic measurements will provide information about the exact coordinates (e.g.—X, Y, Z and/or theta directions) for each feature or opening within the working envelope of the automated programming system 100. The present invention may employ a one, two, three, or four dimensional coordinate system.

The optics system 222 employs optical methods based upon reflectivity and specifically designed algorithms to calculate the exact coordinates for each feature or opening. This system is designed in such a way that the operator no longer has to manually determine the exact coordinates of each feature or opening, which saves the operator time and prevents operator input error.

Referring now to FIG. 3, therein is shown an overview of the automated location system 300 in accordance with an embodiment of the present invention. The automated location system 300 includes the optics system 222, a substrate 302 (such as a platen), the receptacle 304, a cavity 306, an optic path 308, a motor encoder/controller 310, and a processing unit 312. By way of example, the automated location system 300 may be a part of the automated programming system 100, of FIG. 1, and the substrate 302 and the receptacle 304 may be placed over the input device receptacle area 202 and/or the output device receptacle area 208, both of FIG. 2. However, it is to be understood that the substrate 302 and the receptacle 304 may be a part of any system that requires transport of devices, media, and/or components.

During operation, the optics system 222 scans back and forth across the substrate 302 and the receptacle 304 detecting changes in reflectivity. For example, the substrate 302 can be a reflective surface and the receptacle 304 can be a non-reflective surface or vice-versa. The substrate 302 is formed under the receptacle 304 and each of the cavity 306 are formed within the receptacle 304.

Per this embodiment, the receptacle 304 is depicted as rectangular in shape; however, this is not to be construed as limiting. In accordance with the present invention, the receptacle 304 may include any design, shape or configuration that permits mapping of the receptacle 304 by the automated location system 300. The receptacle 304 may include one or more of the cavity 306 for holding device, media and/or components. Furthermore, in accordance with the present invention, the cavity 306 may include any design, shape or configuration that permits containment of device, media and/or components.

As the optics system 222 scans the substrate 302 and the receptacle 304, the optic path 308 may experience transitions that can be registered by the optics system 222. These transitions in the optic path 308 register as a change in reflectivity through a sensor within the optics system 222. By way of example, the transitions may register in digital format, wherein the optics system 222 reads low when energy is reflected back from the substrate 302 and high when there is no reflection from the receptacle 304. A signal representing this change in reflectivity is then sent to the motor encoder/controller 3 10. The motor encoder/controller 310 tracks the movements of the optics system 222 and assigns a value to this signal. By way of example, the change in reflectivity/signal may represent the location of one of the cavity 306. The motor encoder/controller 310 then sends this value to the processing unit 312, such as a computer, for example. The processing unit 312 processes this value (i.e.—the location of the change in reflectivity) and assigns a coordinate position for later use.

As an exemplary illustration, the motor encoder/controller 310 may gauge the distance traveled by the optics system 222 by counting the motor pulses of the motor encoder/controller 310 or units of measurement, such as millimeters. For example, the pulses of the motor encoder/controller 310 may be a specified number of rotations of a sprocket, a drive wheel, or any other type of mechanism that has a relatively constant magnitude of motion with respect to the distance traveled by the optics system 222. These motor pulses are then fed to the processing unit 312, wherein a program or software stored and executed within the processing unit 312 can track the position or location of the optics system 222. The program or software of the processing unit 312 converts the motor pulses of the motor encoder/controller 310 into X, Y, Z and/or theta directions corresponding to the number of motor pulses in the X, Y, Z and/or theta directions.

In accordance with an aspect of the present invention, the shift associated with the perceived location of the teaching targets can be minimized by tightly coupling the optics system 222 with the motor encoder/controller 3 10.

Furthermore, it is to be understood that the bottom of the cavity 306 may or may not be formed by the substrate 302.

Referring now to FIG. 4, therein is shown a plan view of the receptacle 304 in accordance with an embodiment of the present invention. The receptacle 304 may also be referred to as a tray, a carrier, or a multi-die handling device, for example. Per the present embodiment, the receptacle 304 can be a standardized JEDEC tray with more than one of the cavity 306 located at the intersection of rows (Y-axis coordinates) and columns (X-axis coordinates). Each of the cavity 306 may also be referred to as a feature, an opening, or a pocket, for example. Although the present embodiment is described using a JEDEC tray, it is to be understood that the present invention is applicable to any transport system that can be used to store one or more devices, media, and/or components within openings of the transport system. Generally, when referring to the cavity 306, a feature, an opening, or a pocket, it is to be understood that the present invention can be referring to the center of such feature, opening, pocket, or the cavity 306.

The present embodiment depicts the receptacle 304 as possessing eight (8) columns demarcated X₁ through X₈ and ten (10) rows demarcated Y₁ through Y₁₀ for a total of eighty (80) of the cavity 306; however, this is not to be construed as limiting. In accordance with the scope of the present invention the receptacle 304 may include any M×N array of more than one of the cavity 306; wherein, M and N are whole integers, either of M or N is greater than one (1), and the number of the cavity 306 is equal to or less than the product of M times N. For example, the receptacle 304 may include five rows and five columns, but need only possess twenty-five (25) or fewer of the cavity 306.

Each of the cavity 306 is assigned a unique coordinate number based on its Y-axis and X-axis coordinates with respect to a reference point 400. The reference point 400 is the common point of reference for all locations within the working envelope of the automated programming system 100, of FIG. 1. In other words, openings (e.g.—the cavity 306) within the working envelope of the automated programming system 100 can be assigned a coordinate value defined with respect to the reference point 400. As an exemplary illustration, the reference point 400 could be a corner of the receptacle 304, such as the top left corner. However, it is to be understood that the present invention is not to be limited to this example. In accordance with the scope of the invention, the reference point 400 may include any common point of reference that is accessible to all locations within the working envelope of the automated programming system 100.

Per this embodiment, the reference point 400 is defined by teaching targets formed in a first direction and in a second direction, wherein the first direction and the second direction are in different directions, such as orthogonal to each other. For example, the teaching targets may include a first reference 402, formed in the first direction, and a second reference 404 formed in the second direction. The teaching targets can be easily created by placing a non-reflective marking against a reflective surface or vice-versa. In this particular embodiment, the first reference 402 and the second reference 404 are non-reflective markings placed against a reflective background.

Once the reference point 400 is determined, features, such as the cavity 306, can be mapped out (i.e.—their X, Y₁ Z, and theta locations determined) with respect to the reference point 400. The location of the cavity 306 can be determined with respect to the reference point 400. For example, after employing the automated location system 300, of FIG. 3, the location of one of the cavity 306 (e.g.—the coordinate position X₁Y₁) could be 10 units in the X direction and 15 units in the Y direction with respect to the reference point 400. Generally, the automated location system 300 scans the receptacle 304 of the present embodiment and creates two lists for the location of each of the cavity 306, an X-list (X₁, X₂, X₃, X₄, X₅, X₆, X₇, and X₈) and a Y-list (Y₁, Y₂, Y₃, Y₄, Y₅, Y₆, Y₇, Y₈, Y₉, Y₁₀.

The values assigned to the X-list and the Y-list are relative to the location of the reference point 400 and each of the cavity 306 can be found for any location within the receptacle 304 as long as the reference point 400 is known. For example, if the reference point 400 is defined by coordinates (Xₐ, Yₐ), then the absolute location for X₁Y₁ can be defined as (Xa+_{10,} Ya+₁₅), using the values ₁₀ and ₁₅ from the example directly above.

After mapping the coordinates for each of the cavity 306, the robotics system 200, of FIG. 2, is able to locate any of the cavity 306 within the receptacle 304 by simply combining different X and Y values. For example, the top left pocket location can be described by the values (X₁, Y₁) and the bottom right pocket can be described the values (X₈, Y₁₀ ).

Although the present embodiment creates two lists (X and Y) for the location of each of the cavity 306, it is to be understood that the present invention may employ any number of spatial coordinates X, Y₁ Z, and theta locations to create lists of two, three, or four values that map the location of each of the cavity 306.

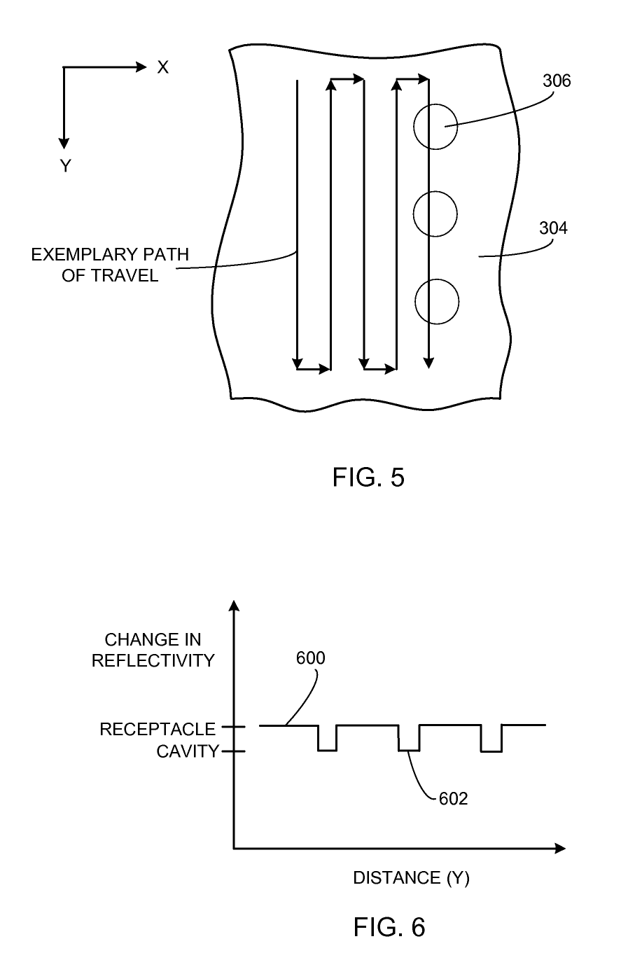

The following steps and FIGs., FIGS. 5-13, depict by way of example and not by limitation, an exemplary process flow, sequence of operations, or method that can be employed during the operation of the automated location system 300, of FIG. 3, and are not to be construed as limiting. Accordingly, it is to be understood that many modifications, additions, and/or omissions may be made to the present invention without departing from the scope or spirit of the claimed subject matter. For example, the sequence of operations described below may include more, fewer, or other steps.

Generally, the method of the present invention includes a system in which features, openings, or pockets are located, not by calculating dimensions of a tray, but by creating lists of feature locations (e.g.—the cavity 306, of FIG. 4). These lists can correspond to the centers of the feature locations along a row and along a column if only a two-dimensional Cartesian coordinate system is employed. For example, if the tray contains 8 columns and 10 rows, the feature locations can be defined as (relative to the reference point 400, of FIG. 4):
X1, X2, X3, X4, X5, X6, X7, X8
Y1, Y2, Y3, Y4, Y5, Y6, Y7, Y8, Y9, Y10

Features, openings, or pockets can be located using the following general sequence of operations.

Step One: Operator Supplies Number of Columns and Rows

The operator supplies the number of columns and rows by manually counting the number of columns and rows of the receptacle 304, of FIGS. 3 and 4. These values are input to the automated programming system 100, of FIG. 1, for example, prior to initiating the automated location system 300, of FIG. 3. By way of example, if the receptacle 304 contains M columns and N rows, wherein M and N are integers, then the operator inputs M columns and N rows.

Step Two: The Automated Location System 300 Locates One of the Cavity 306 Along a First Axis

Referring now to FIG. 5, therein is shown an exemplary initial path of travel over the receptacle 304 for the optics system 222, of FIG. 3, in accordance with an embodiment of the present invention. Per this embodiment, the optics system 222 is positioned at an arbitrary location over the receptacle 304 for its initial scan. The optics system 222 is then moved along a first axis of the receptacle 304 that is oriented in a first direction. By way of example, the first axis can be the major axis of the receptacle 304, such as the Y-axis. As the optics system 222 traverses or passes over the receptacle 304, sensors within the optics system 222 detect optic transitions or changes in reflectivity emitted by the receptacle 304.

If the optics system 222 fails to detect an opening, feature or pocket, such as the cavity 306, the optics system 222 can continue until it recognizes that it has gone off the receptacle 304 (e.g.—detects a change in reflectivity due to its position over the substrate 302, of FIG. 3) and then change directions. However, it is to be understood that the optics system 222 need not travel off the receptacle 304 before changing directions. In accordance with the scope of the present invention, the path of travel of the optics system 222 may include any preset distance that is less than the length of the receptacle 304 before changing directions.

Nonetheless, once the optics system 222 recognizes that it has traveled its required distance without detecting one of the cavity 306, the optics system 222 stops and then makes a small incremental step in the X-direction and begins traveling in an opposite direction (i.e.—changes direction). For example, if the optics system 222 initially began traveling in a minus Y-direction along the first axis, then the optics system 222 will travel in a plus Y-direction after it makes its small incremental step in the X-direction. Once again, as the optics system 222 traverses the receptacle 304, sensors within the optics system 222 detect optic transitions or changes in reflectivity emitted by the receptacle 304.

This process is repeated until one or more of the cavity 306 is located during a pass of the optics system 222 over the receptacle 304. Once the automated location system 300, of FIG. 3, recognizes that it has encountered at least one of the cavity 306, the automated location system 300 then calculates the Y-value for the center of the cavity 306 with the largest dimension or opening. By way of example, the Y-value assigned to the cavity 306 with the largest opening can be an absolute value from the robotics system 200, of FIG. 2, home or origin.

Referring now to FIG. 6, therein is shown a graph of exemplary results of an optics scan in accordance with an embodiment of the present invention. This illustration depicts how the changes in reflectivity registered by the optics system 222, of FIG. 3, can be plotted against distance (e.g.—a Y value) for step two of the present invention. These exemplary results demonstrate how a signal top 600 can be interpreted to represent the receptacle 304, of FIG. 3, and a signal bottom 602 can be interpreted to represent the cavity 306, of FIG. 3.

Step Three: Scan Across a Second Axis

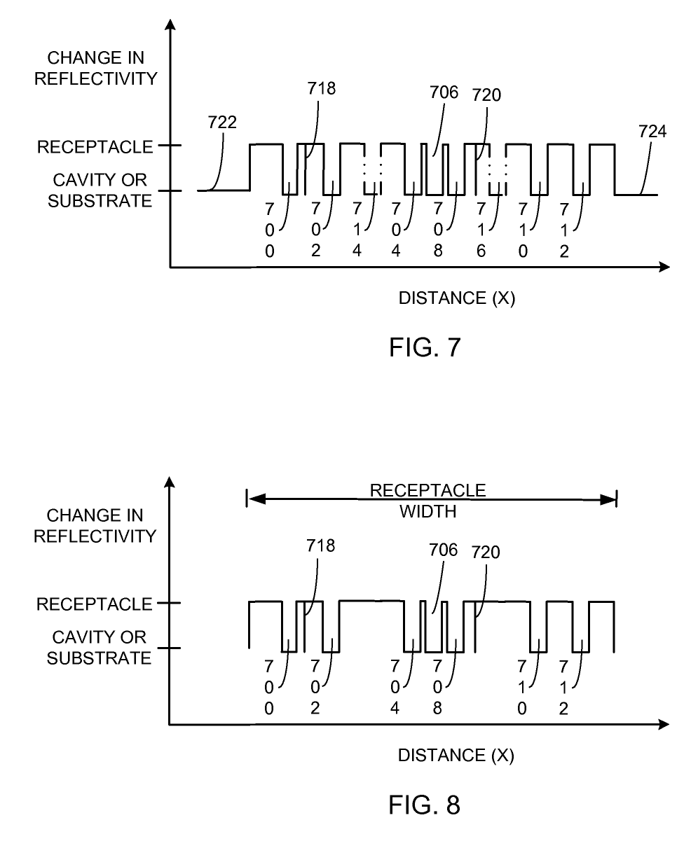

Referring now to FIG. 7, therein is shown a graph of the exemplary results of a scan across the receptacle 304, of FIG. 3, in accordance with an embodiment of the present invention. Although the present embodiment corresponds to an eight (8) column scan, it is to be understood that the automated location system 300, of FIG. 3, can scan across any number of columns or across any axis. The second axis scan across the receptacle 304 is initiated after aligning the optics system 222, of FIGS. 2 and 3, outside a boundary of the receptacle 304. By way of example, the optics system 222 can be aligned outside the left boundary of the receptacle 304 using the Y-value obtained from step two. By aligning the optics system 222 with the Y-value obtained for the cavity 306, of FIG. 5, the optics system 222 can scan over the receptacle 304 in a second direction, such as along the X-axis direction, and locate each of the cavity 306 associated with the current row or second axis.

The present embodiment depicts a scan that detected seven (7) openings/features/pockets or seven of the cavity 306 along the second axis of the receptacle 304. The seven openings correspond to locations described by a first opening 700, a second opening 702, a fourth opening 704, a fourth prime opening 706, a fifth opening 708, a seventh opening 710, an eighth opening 712. The scan also shows two missing openings corresponding to a third opening 714 (shown in phantom outline) and a sixth opening 716 (shown in phantom outline), as well as, two false openings depicted by a false signal 718 and a false signal 720. Per this embodiment, it is to be understood that the third opening 714 and the sixth opening 716 are not depicted by the scan, and are being provided in phantom outline merely for purposes of clarity. Angular irregularities associated with the construction of the receptacle 304 may cause the optics system 222 to register perceived changes in reflectivity, thereby creating “false openings”, such as the fourth prime opening 706, the false signal 718 and the false signal 720, that can be of variable widths.

The two missing openings (i.e.—the third opening 714 and the sixth opening 716) can be pockets within the receptacle 304 without holes. By way of example, pockets without holes may include pockets with a solid bottom such that energy cannot be seen reflected from the substrate 302, of FIG. 3, because it is not exposed.

Additionally, the scan of the present embodiment detected a hole (i.e.—the fourth prime opening 706) between the fourth opening 704 and the fifth opening 708. The fourth prime opening 706 appears to be a hole not contained within a pocket of the receptacle 304.

The signal lows as plotted against the vertical axis (i.e.—changes in reflectivity) can be associated with the reflective surface of the substrate 302. For example, each of the seven openings (i.e.—the first opening 700, the second opening 702, the fourth opening 704, the fourth prime opening 706, the fifth opening 708, the seventh opening 710, and the eighth opening 712), a signal start trace 722 and a signal stop trace 724 are at comparatively low levels indicating that the optics system 222 is over the reflective surface of the substrate 302.

Step Four: Determine Width of the Receptacle 304

Referring now to FIG. 8, therein is shown the structure of FIG. 7 after removal of the signal start trace 722, of FIG. 7, and the signal stop trace 724, of FIG. 7, in accordance with an embodiment of the present invention. The scan includes the first opening 700, the second opening 702, the fourth opening 704, the fourth prime opening 706, the fifth opening 708, the seventh opening 710, the eighth opening 712, the false signal 718, and the false signal 720. By knowing that the optics system 222, of FIGS. 2 and 3, starts and stops its scan over the substrate 302, of FIG. 3, (e.g.—a reflective surface), the width of the receptacle 304, of FIG. 3, can be determined by removing the signal start trace 722 and the signal stop trace 724.

Step Five: Remove False Signals

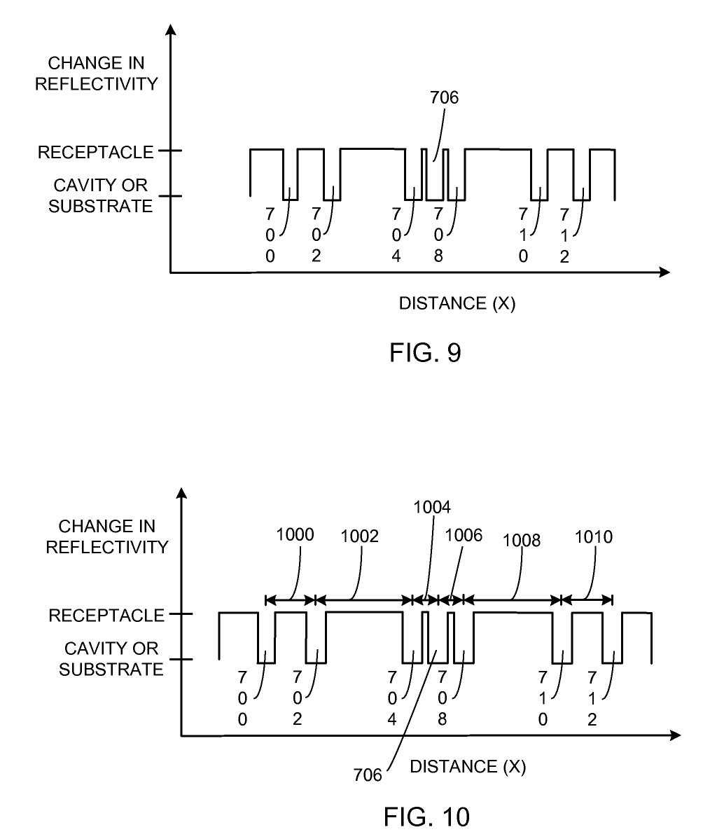

Referring now to FIG. 9, therein is shown the structure of FIG. 8, after removal of the false signal 718, of FIG. 8, and the false signal 720, of FIG. 8, in accordance with an embodiment of the present invention. The scan includes the first opening 700, the second opening 702, the fourth opening 704, the fourth prime opening 706, the fifth opening 708, the seventh opening 710, and the eighth opening 712. False readings or signals can be detected by assuming that an opening (i.e.—the cavity 306, of FIG. 4) must have a minimum dimension (e.g.—diameter). By way of example and not by way of limitation, the minimum dimension could be preset to any value that has been shown to empirically best eliminate false readings or signals. By applying this type of filter, the false signal 718 and the false signal 720 can be removed because they do not possess a dimension that exceeds the preset minimum dimension.

Step Six: Determine List of Pitches

Referring now to FIG. 10, therein is shown the structure of FIG. 9, after determining pitch between openings in accordance with an embodiment of the present invention. The scan includes the first opening 700, the second opening 702, the fourth opening 704, the fourth prime opening 706, the fifth opening 708, the seventh opening 710, and the eighth opening 712. The scan of the present embodiment also depicts six pitches: a first pitch 1000, a second pitch 1002, a third pitch 1004, a fourth pitch 1006, a fifth pitch 1008, and a sixth pitch 1010. The first pitch 1000 represents the distance between the second opening 702 and the first opening 700. The second pitch 1002 represents the distance between the fourth opening 704 and the second opening 702. The third pitch 1004 represents the distance between the fourth prime opening 706 and the fourth opening 704. The fourth pitch 1006 represents the distance between the fifth opening 708 and the fourth prime opening 706. The fifth pitch 1008 represents the distance between the seventh opening 710 and the fifth opening 708. The sixth pitch 1010 represents the distance between the eighth opening 712 and the seventh opening 710.

Per this invention, pitch is defined to mean the distance from the center of one opening (e.g.—the cavity 306, of FIGS. 3 and 4) to the center of an adjacent opening (e.g.—an adjacent one of the cavity 306).

Although the present embodiment depicts an illustration wherein some of the openings appear to have a substantially equal pitch, this is not always the case. Commonly, there exist small variations in pitch readings along the length of the scan. For example, measured distances from one opening to the next may appear as a first pitch list. The following is as exemplary first pitch list:
the first pitch 1000=101234
the second pitch 1002=202309
the third pitch 1004=832
the fourth pitch 1006=906
the fifth pitch 1008=202344
the sixth pitch 1010=101189

The above distances can be measured in units of any type, but for purposes of discussion and for clarity, the above distances will be referred to as encoder count units; however, this is not to be construed as limiting.

Step Seven: Determine Similar Pitches

After analyzing the first pitch list measured in step six, it becomes apparent that some values are close enough to be considered substantially the same. Similar pitches can be detected by determining that if two values are within a predetermined distance, then they are deemed substantially equivalent. For example, if two or more pitch values are within two hundred (200) encoder count units of each other, they will be averaged and considered the same. For example, the first pitch 1000 (101234 encoder counts) can be added to the sixth pitch 1010 (101189 encoder counts) and averaged to produce an encoder count value of 101212. After performing this process, a second pitch list can be formed. The following is as exemplary second pitch list:
the first pitch 1000=101212
the second pitch 1002=202327
the third pitch 1004=869
the fourth pitch 1006=869
the fifth pitch 1008=202327
the sixth pitch 1010=101212

Now, the list of pitches can be reduced to three (3) values and a third pitch list can be formed. The following is as exemplary third pitch list:
Pitch one (P₁)=101212
Pitch Two (P₂)=202327
Pitch Three (P₃)=869

Step Eight: Determine Correct Pitch

Now that the width of the receptacle 304, of FIGS. 3 and 4, is known from step four and the number of the cavity 306, of FIG. 3, (N₁), contained along a second axis is known, the minimum width of the receptacle 304 can be calculated. The minimum width of the receptacle 304 can be determined from the following equation:

Minimum receptacle width=(N₁−1)×Pₙ;
wherein N₁ equals the number (e.g.—eight) of the cavity 306 located along a second axis or row of the receptacle 304 and Pₙ refers to one of the pitches from the third pitch list determined in step seven, wherein (ₙ) equals a positive integer.

Using the values of the third pitch list from step seven, the following values are yielded:

Receptacle minimum width one=(8−1)×P₁=(7×101212)=708484

Receptacle minimum width two=(8−1)×P₂=(7×202327)=1416289

Receptacle minimum width three=(8−1)×P₃=(7×869)=6083

For example, if the measured width of the receptacle 304, as determined in step four, is 950908 encoder units, then receptacle minimum width two can be automatically ruled out as that value exceeds the measured value of the tray. The correct pitch is receptacle minimum width one as it has the maximum value while still remaining within the confines of the measured tray width. Consequently, pitch one (P₁) from the third pitch list, is determined to be the correct pitch value.

Step Nine: Determine Openings Based Upon Pitch

Referring now to FIG. I 1, therein is shown the structure of FIG. 10 with the fourth prime opening 706, of FIG. 7, removed, in accordance with an embodiment of the present invention. The scan of the present embodiment includes the first opening 700, the second opening 702, the fourth opening 704, the fifth opening 708, the seventh opening 710, and the eighth opening 712.

The automated location system 300, of FIG. 3, is able to eliminate the fourth prime opening 706 by employing the correct pitch (e.g.—pitch one (P₁)) determined from step eight. Step eight determined that the correct pitch between each of the cavity 306, of FIG. 3, was pitch one (P₁). Using this information, the automated location system 300 can locate an “anchor” opening to determine the maximum number of correctly identified features, openings, or pockets along a second axis or a row. By way of example, the “anchor” opening may include an opening that provides the maximum number of correct hits when multiples of the correct pitch (e.g.—pitch one (P₁)) are added to the “anchor” opening. The automated location system 300 locates the correctly identified openings by determining the coordinate position (e.g.—an (X,Y) value) of the “anchor” opening and adding and/or subtracting multiples of the correct pitch along an axis from this coordinate position.

This method allows the automated location system 300 to employ any of the openings (e.g.—the first opening 700, the second opening 702, the fourth opening 704, the fifth opening 708, the seventh opening 710, and the eighth opening 712) plotted by the scan of step five. Additionally, if the automated location system 300 chooses the fourth prime opening 706 as the “anchor” opening to calculate from, the automated location system 300 can readily identify that none of the other openings align with the fourth prime opening 706 when adding and/or subtracting multiples of the correct pitch from this “anchor” opening coordinate position. If this event transpires, the automated location system 300 will automatically designate another one of the openings as the “anchor” opening and re-calculate.

The following example will calculate the location of each opening with respect to the first opening 700 designated as the “anchor” opening. This example is given merely for purposes of illustration and is not to be construed as limiting.

the second opening 702 location=the first opening 700 location+(1×P₁)

the fourth opening 704 location=the first opening 700 location+(3×P₁)

the fifth opening 708 location=the first opening 700 location+(4×P₁)

the seventh opening 710 location=the first opening 700 location+(6×P₁)

the eighth opening 712 location=the second opening 702 location+(6×P₁)

By employing the correct pitch (e.g.—pitch one (P₁)), the automated location system 300 is able to determine that the fourth prime opening 706 does not reside within the cavity 306, of FIGS. 3 and 4. The automated location system 300 is able to determine this because the fourth prime opening 706 is not located/encountered when adding and/or subtracting multiples of the correct pitch from the “anchor” opening.

Step Ten: Fill in Missing Openings

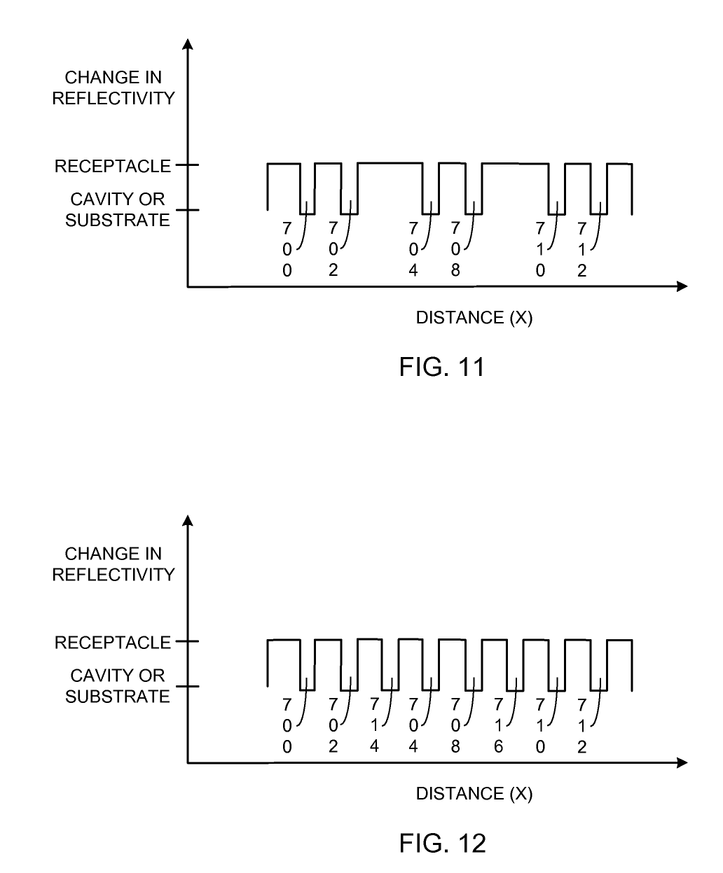

Referring now to FIG. 12, therein is shown the structure of FIG. 11, after filling in the third opening 714 and the sixth opening 716, in accordance with an embodiment of the present invention. The scan of step nine indicated the presence of six openings, but the receptacle 304, of FIG. 4, includes eight openings formed along the second axis (i.e.—the X-axis). The automated location system 300, of FIG. 3, is able to rectify the incorrect number of openings by checking for the presence of an adjacent opening by adding the correct pitch (e.g.—pitch one (P₁)) to a current opening location. By performing this procedure, it is possible to determine if an opening was undetected.

For example, by adding the correct pitch (e.g.—pitch one (P₁)) to the location of the first opening 700, the presence of the second opening 702 can be verified. If the automated location system 300 then adds the correct pitch (e.g.—pitch one (P₁)) to the location of the second opening 702, it can be determined that no feature, opening, or pocket exists. Upon this discovery, the automated location system 300 then creates an opening for the third opening 714 by adding the correct pitch (e.g.—pitch one (P₁)) to the location of the second opening 702. This process is repeated until the correct number of openings is obtained.

Step Eleven: Create a List of Opening Locations Along the Second Axis (e.g.—a Row)

Feature, opening, or pocket locations are determined for each of the cavity 306, of FIG. 4, along a second axis (e.g.—an X-axis) by finding the center of each of the cavity 306. The center of each of the cavity 306 corresponds to the center of each feature, opening or pocket. The list produced by the automated location system 300, of FIG. 3, provides, per this example, a list of X value locations (e.g.—an X values list) for each of the openings as follows for the receptacle 304, of FIG. 4:
the first opening 700 location=X1
the second opening 702 location=X2
the third opening 714 location=X3
the fourth opening 704 location=X4
the fifth opening 708 location=X5
the sixth opening 716 location=X6
the seventh opening 710 location=X7
the eighth opening 712 location=X8

Since the scan performed by the optics system 222, of FIG. 3, provides the absolute X-value location for each of the opening (e.g.—the cavity 306) with respect to a robot home, the X-value list for each opening location is calculated by subtracting the location of the reference point 400, of FIG. 4.

Step Twelve: Determine List of Opening Locations Along the First Axis (e.g.—a Column)

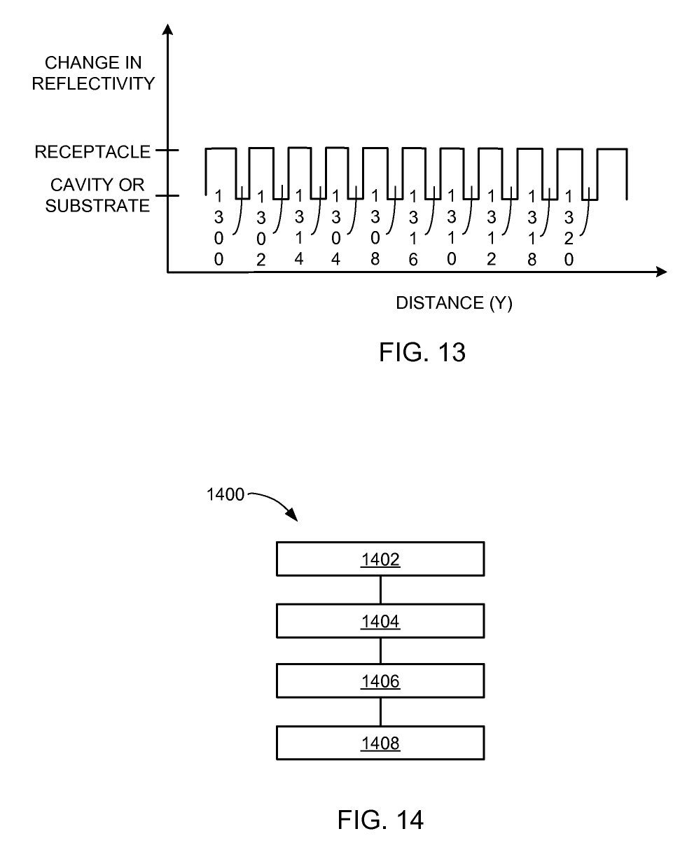

Referring now to FIG. 13, therein is shown a graph of a scan along the first axis after performing steps three through eleven, in accordance with an embodiment of the present invention.

Feature, opening, or pocket locations positioned along the first axis (e.g.—a Y-axis) can be determined by repeating steps three through eleven for a scan taken along the first axis. The first axis or column to be scanned can be located by using one of the X-values found in step eleven for the scan of the second axis. The result of performing steps three through eleven for a first axis or column scan can yield the following Y-list (e.g.—a Y values list) for the receptacle 304, of FIG. 4:
a first opening 1300 location=Y1
a second opening 1302 location=Y2
a third opening 1314 location=Y3
a fourth opening 1304 location=Y4
a fifth opening 1308 location=Y5
a sixth opening 1316 location=Y6
a seventh opening 1310 location=Y7
a eighth opening 1312 location=Y8
a ninth opening 1318 location=Y9
a tenth opening 1320 location=Y10

Feature, Opening or Pocket Coordinates

During execution of a job, the robotics system 200, of FIG. 2, can locate any opening (i.e.—the cavity 306, of FIG. 4) within the receptacle 304, of FIG. 4, by combining different X and Y values. For example, the top left opening of an eight column and ten row tray can be located by combining X₁ and Y₁ (X₁,Y₁) and the bottom right opening can be located by combining X₈ and Y₁₀ (X₈, Y₁₀ ). It is to be understood that the X values provided by the X-list and the Y values provided by the Y-list can be added to the value of the reference point 400, of FIG. 4.

The two lists (X₁, X₂, X₃, X₄, X₅, X₆, X₇, X₈) and (Y₁, Y₂, Y₃, Y₄, Y₅, Y₆, Y₇, Y₁₀ ) make up the tray map for the receptacle 304 and these values can be applied to any transport system contained anywhere within the working envelope of a handling robot.

Referring now to FIG. 14, therein is shown a flow chart of an automated location system 1400 for the automated location system 300 in accordance with an embodiment of the present invention. The automated location system 1400 includes providing the number of rows and columns of a receptacle to the automated location system in a block 1402; scanning the receptacle to determine changes in reflectivity in a block 1404; creating an X values list and a Y values list from the scan in a block 1406; and determining a location for each of a cavity from the X values list and from the Y values list in a block 1408.

From the above it will be understood that the present invention is applicable to what can be described as “devices”, “media” or “components”. Devices, media and/or components include a broad range of electronic and mechanical devices. The best mode describes programming of devices, media and/or components, which include, but are not limited to, Flash memories (Flash), electrically erasable programmable read only memories (EEPROM), programmable logic devices (PLDs), field programmable gate arrays (FPGAs), and microcontrollers. However, the present invention encompasses programming for all electronic, mechanical, hybrid, and other devices, media and/or components, which require testing, measurement of device characteristics, calibration, and other programming operations. For example, these types of devices, media and/or components would include, but not be limited to, microprocessors, integrated circuits (ICs), application specific integrated circuits (ASICs), micro mechanical machines, micro-electro-mechanical (MEMs) devices, micro modules, and fluidic systems.

It has been discovered that the present invention thus has numerous aspects. One such aspect is the ability of the automated location system to determine the number and location of cavities, automatically, after an operator merely enters the number of rows and columns of a receptacle.

Yet another aspect of the present invention is that it valuably supports and services the historical trend of reducing costs, simplifying systems, and increasing performance.

These and other valuable aspects of the present invention consequently further the state of the technology to at least the next level.

Thus, it has been discovered that the automated location system of the present invention furnishes important and heretofore unknown and unavailable solutions, capabilities, and functional aspects that do not require a high level of operator interaction to locate features. The resulting processes and configurations are straightforward, cost-effective, uncomplicated, highly versatile and effective, can be implemented by adapting known technologies, and are thus readily suited for efficiently and economically manufacturing integrated circuit package devices.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations, which fall within the scope of the included claims. All matters hitherto fore set forth herein or shown in the accompanying drawings are to be interpreted in an illustrative and non-limiting sense.

What is claimed is:

1. An automated location system comprising:
providing the number of rows and columns of a receptacle to the automated location system;
scanning the receptacle to determine changes in reflectivity;
creating an X values list and a Y values list from the scan; and
determining a location for each of a cavity from the X values list and from the Y values list.

2. The system as claimed in claim 1 wherein:
creating the X values list and the Y values list from the scan includes removing a false signal.

3. The system as claimed in claim 1 wherein:
creating the X values list and the Y values list from the scan includes determining the correct pitch.

4. The system as claimed in claim 1 wherein:
creating the X values list and the Y values list from the scan includes filling in missing openings.

5. The system as claimed in claim 1 wherein:
determining a location for each of the cavity includes locating the center for each of the cavity.

6. An automated location system comprising:
scanning a first reference and a second reference to establish a reference point;
providing the number of rows and columns of a receptacle to the automated location system;
initiating a scan along a second axis of the receptacle to create an X values list for each of a cavity located along the second axis;
initiating a scan along a first axis of the receptacle to create a Y values list for each of the cavity located along the first axis; and
determining a location for each of a cavity within the receptacle using the X values list and the Y values list.

7. The system as claimed in claim 6 wherein:
initiating a scan along a second axis of the receptacle to create the X values list includes using a Y value from an initial scan of the receptacle.

8. The system as claimed in claim 6 wherein:
initiating a scan along a first axis of the receptacle to create the Y values list includes using an X value from the X values list to position an optics system.

9. The system as claimed in claim 6 further comprising:
creating the X values list and the Y values list by averaging substantially similar pitches.

10. The system as claimed in claim 6 further comprising:
creating the X values list and the Y values list by calculating the width of the receptacle.

11. A automated location system comprising:
a receptacle having a number of rows and columns;
an optics system for scanning the receptacle; and
a computer for determining the location of each of a cavity by creating an X values list and a Y values list from the number of rows and columns.

12. The system as claimed in claim 11 further comprising:
a substrate under the receptacle.

13. The system as claimed in claim 12 wherein:
the substrate is reflective and the receptacle is non-reflective.

14. The system as claimed in claim 11 wherein:
the receptacle includes the cavity.

15. The system as claimed in claim 11 wherein:
the receptacle includes substantially centered columns and substantially centered rows.

16. The system as claimed in claim 11 wherein:
the optics system detects changes in reflectivity from the receptacle.

17. The system as claimed in claim 11 wherein:
the X values list and the Y values list are determined with respect to a reference point.

18. The system as claimed in claim 11 wherein:
the X values list and the Y values list locates the center for each of the cavity.

19. The system as claimed in claim 11 further comprising:
a motor encoder/controller for tracking the movement of the optics system.

20. The system as claimed in claim 11 wherein:
the automated location system may be part of an automated programming system.
